(19) United States
(12) Patent Application Publication
(10) Pub. No.: US 2002/0162441 A1
(43) Pub. Date: Nov. 7, 2002

(54) Portable support for chain saw

(76) Inventor: Jacques Dumas, Levis (CA)

Correspondence Address: GOUDREAU GAGE DUBUC, 800 PLACE VICTORIA, SUITE 3400, MONTREAL, QUEBEC, H4Z 1E9, CA

(21) Appl. No.: 09/730,580

(22) Filed: Dec. 7, 2000

(51) Int. Cl. B26D 5/08

(52) U.S. Cl. 83/796; 83/574

(57) ABSTRACT

A portable chain saw support, for mounting a chain saw to a structure is described herein. The portable chain saw support comprises a longitudinal body, a chain saw mounting bracket, pivotally mounted to the body, and an anchoring assembly to secure the body to the structure. A chain guard is provided on the mounting bracket to cover the blade of the saw. The chain saw support also includes a motion stopper to limit the travel of the saw and a cutting guide.

### FIELD OF THE INVENTION

The present invention relates to chain saws. More specifically, the present invention is concerned with a portable support for a chain saw.

### BACKGROUND OF THE INVENTION

Chain saws are commonly used for felling and bucking timber. Conventionally a chain saw has, at one end, a power unit including a motor, motor controls and handles, and, at the other end, a chain saw bar having, at its periphery, a chain of movable teeth driven by the motor.

A major disadvantage of chain saws is that they may cause serious injuries to their operator, due to their tendency to get out of control while running.

Another disadvantage of chain saws is their weight. Even though the handles allow the operation of the chain saw by a single person, they inevitably fatigue the operator after long and repeated uses. Moreover, their safe use is often restricted to people having good physical condition.

Means to support a chain saw during its operation allow both its uses by people having normal or poor physical strength and also allow the risk of injuries to be minimized.

Examples of such chain saw supports are disclosed in the U.S. Pat. No. 4,350,067, issued on Sep. 21, 1982 to Picard and in the U.S. Pat. No. 4,210,049, issued on Jul. 1^{st}, 1980 and naming Gauthier as the inventor.

A major drawback of such prior art chain saw supports is that they are bulky and difficult to transport. Moreover, chain saw supports from the prior art require to be mounted to a unique predetermined structure in order to be operated.

### SUMMARY OF THE INVENTION

More specifically, in accordance with the present invention, there is provided A portable chain saw support for mounting a chain saw having a power unit to a structure, the support comprising:

a body;

an anchoring assembly mounted to the body; the anchoring assembly being configured to removably mount the body to the structure;

a chain saw mounting bracket pivotally mounted to the body; the chain saw mounting bracket being so configured as to removably receive the chain saw for reciprocal movements between an non-cutting position and a cutting position; and

a chain saw rest so mounted to the body so as to receive the power unit of the chain saw when the chain saw is in the non-cutting position.

Other objects, advantages and features of the present invention will become more apparent upon reading of the following non restrictive description of preferred embodiments thereof, given by way of example only with reference to the accompanying drawings.

### BRIEF DESCRIPTION OF THE DRAWINGS

In the appended drawings:

FIG. 1 is a perspective view of a portable chain saw support according to a preferred embodiment of the present invention, illustrated mounted to a work table;

FIG. 2 is a front elevational view of the portable chain saw support of FIG. 1;

FIG. 3 is a side elevational view of the portable chain saw support of FIG. 1, illustrated supporting a chain saw;

FIG. 4 is a perspective view of the portable chain saw support of FIG. 1, illustrated with a log and supporting a chain saw;

FIG. 5 is a side elevational view of the portable chain saw support of FIG. 1, illustrated with a log and supporting a chain saw in a first position before cutting the log;

FIG. 6 is a side elevational view of the portable chain saw support of FIG. 1, illustrated with a log and supporting a chain saw in a second position after cutting the log; and

FIG. 7 is a perspective view of a portable chain saw support according to a preferred embodiment of the present invention, illustrated mounted to a tree bole.

### DESCRIPTION OF THE PREFERRED EMBODIMENT

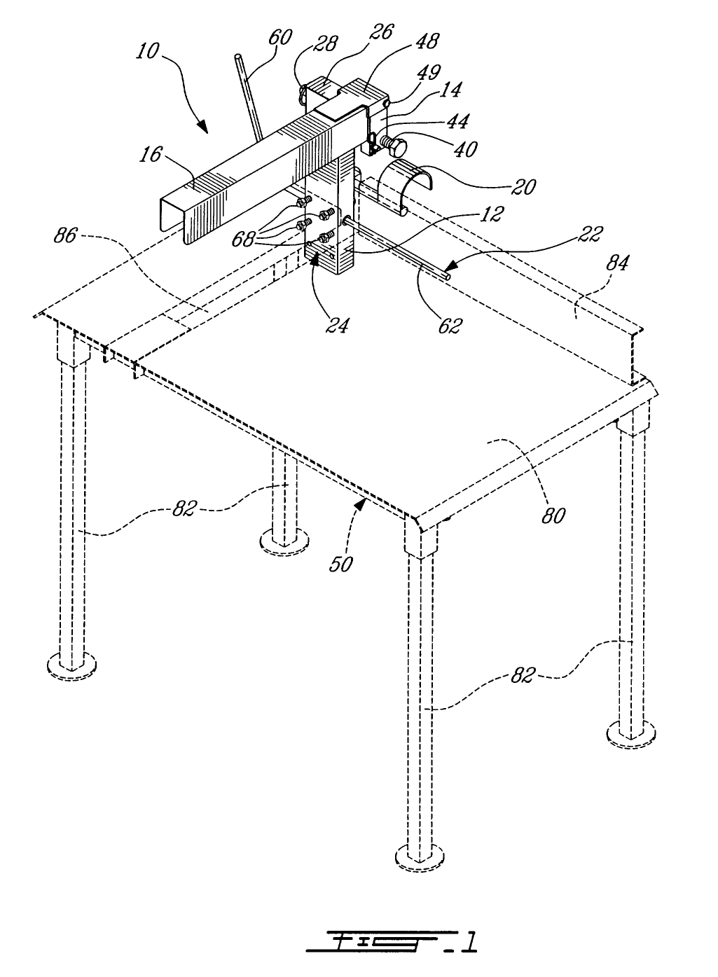

Turning now to FIGS. 1 to 6 of the appended drawings, a portable chain saw support 10, for mounting a chain saw to a structure, according to a preferred embodiment of the present invention will be described.

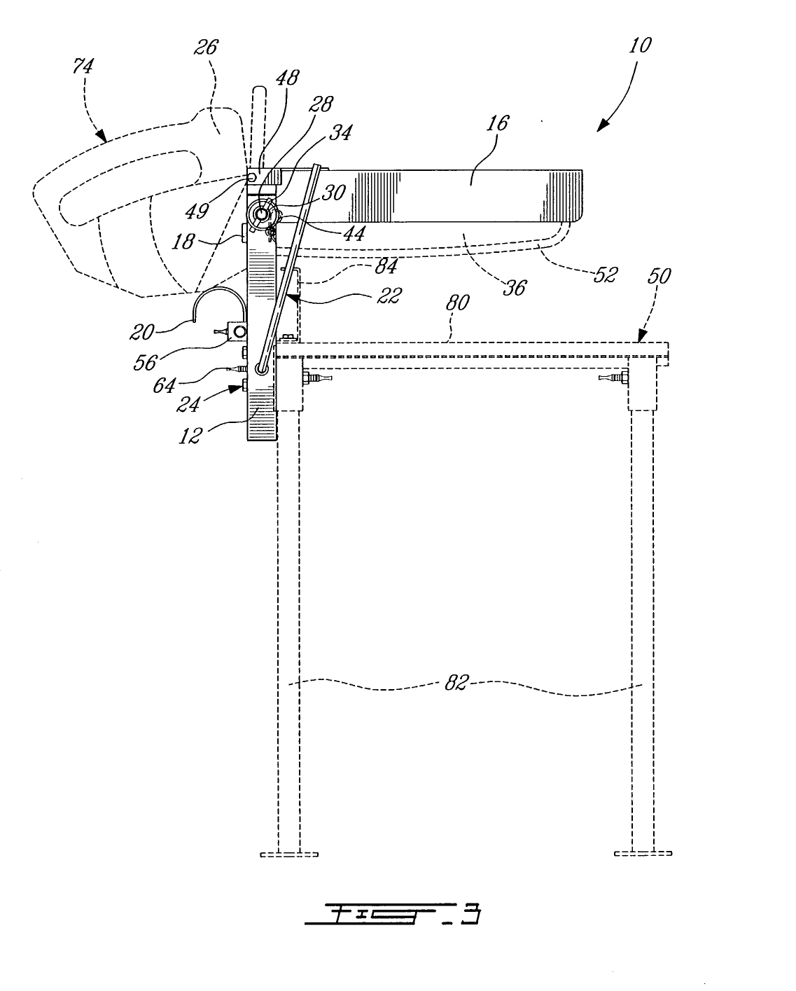

The portable chain saw support 10 comprises a longitudinal body 12, a chain saw mounting bracket 14, a chain guard 16, a motion stopper 18 (FIG. 3), a chain saw rest 20, a cutting guide 22 and an anchoring assembly 24.

The body 12 is advantageously in the form of a hollow rectangular column that allows the components of the portable chain saw support 10 to be supported and easily mounted. The body 12 is made of metal or of any other rigid material.

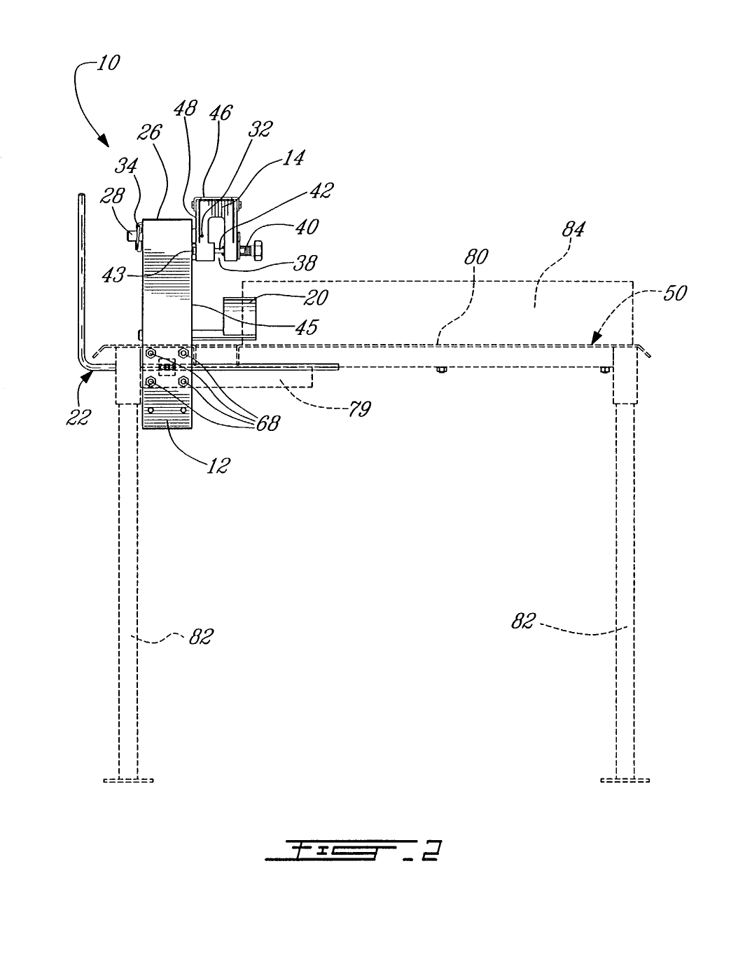

As can be better seen from FIG. 2, the chain saw mounting bracket 14 has an inverted “U” shape defining an inter-space 38. The mounting bracket 14 is pivotally mounted to the body 12 near its proximate end 26 via a pivot pin 28. The pivot pin 28 is inserted in a first transversal aperture of the body 12. A cylinder 30, advantageously made of metal, is provided between the pivot 28. The pivot pin 28 is so mounted in the cylinder 30 as to snugly fit therein. The cylinder 30 gives strength and allows the bracket 14 to be adequately secured. A pressure screw 32 prevents any transversal movement of the cylinder 30 in the mounting bracket 14. A safety pin 34 prevents transversal movements of the pivot pin 28 in the cylinder 30.

The chain saw bar 36 of the chain saw 26 is mounted in the inter-space 38 and is advantageously secured to the mounting bracket 14 via both a clamping bolt 40.

A removable pin 42 is also provided for safety reason. The pin 42 is received in a second transversal aperture in the mounting bracket 14 and can be locked in position via a safety pin 44. Obviously, an aperture has to be scored beforehand in the chain saw bar 36 in order to receive the pin 42. It is to be noted that the pin 42 has an inwardly projection portion 43.

The removable pin 42 allows to maintain a chain saw in the chain saw support 10 if the clamping bolt 40 looses.

For stability purposes, the two chain saw bar securing elements 40 and 42 are advantageously spaced apart in the longitudinal direction of the chain saw bar 36.

It is believed to be within the reach of a person skilled in the art to conceive different chain saw bar securing elements.

It is to be noted that the body 12 and the mounting bracket 14 are advantageously provided with facing flat surfaces 45 and 46 that facilitate the alignment of the chain saw bar 36 as will become more apparent upon reading the following description.

The chain saw support 10 is advantageously provided with a chain guard 16 having an inverted “U” cross-section. The guard 16 is pivotally mounted to the bracket 14 via a mounting plate 48 and a pivot pin 49. The mounting plate 48 allows the chain saw guard 16 to reciprocate between a non-cutting position and a cutting position where it covers a portion of the saw 74.

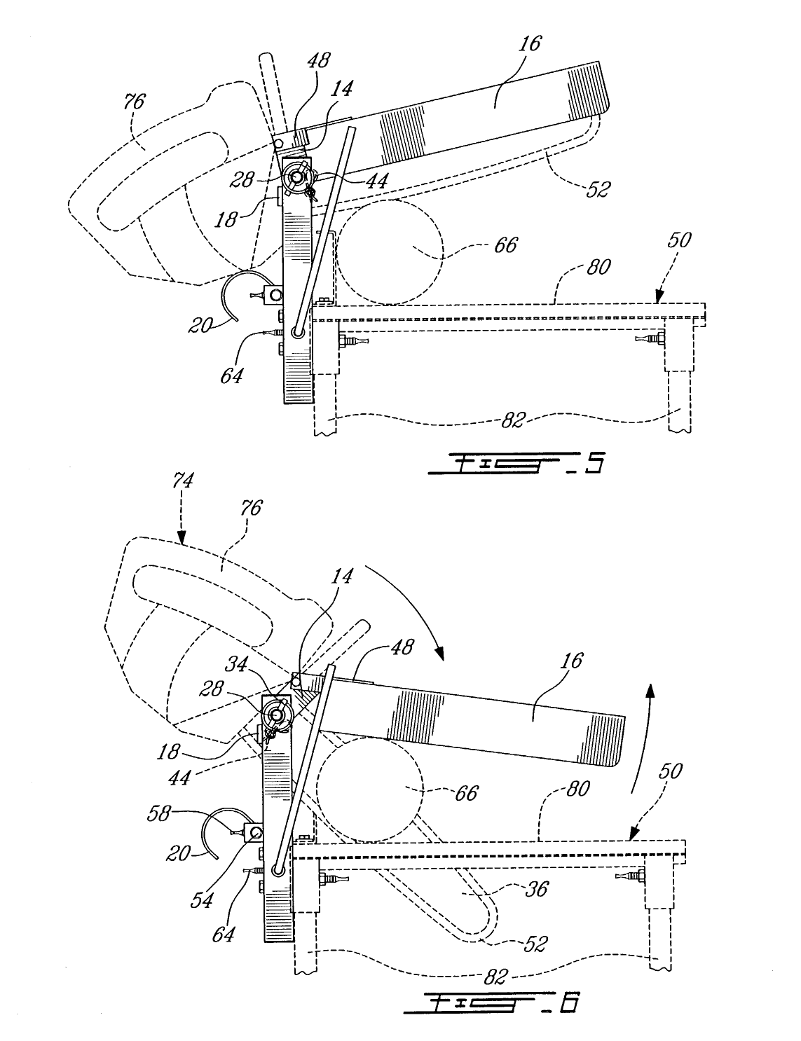

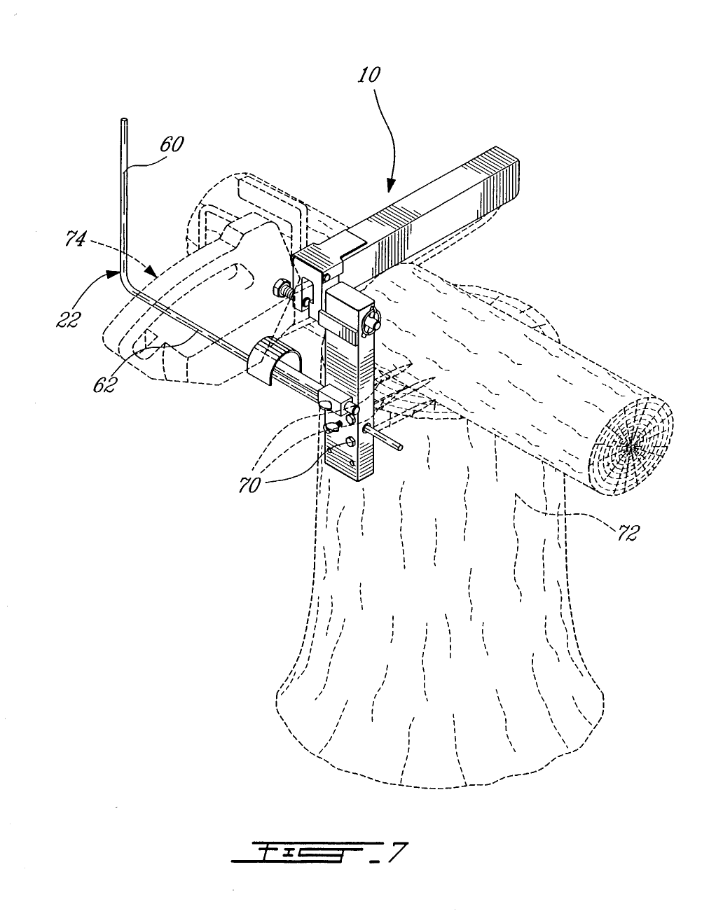

In the non-cutting position (see FIG. 5), the mounting plate 48 rests flat on the top surface of the mounting bracket 14. In the cutting position (see FIG. 6), the mounting plate 48 is positioned at an angle greater than 90 degrees with the top surface of the mounting bracket 14. This allows the mounting bracket 14 to pivot downward even when a log 66 stops the pivoting movement of the chain saw guard 16 (see FIG. 6).

Obviously, the optional chain guard 16 may have other shapes and configurations.

An optional stopper 18 (see FIG. 3), in the form of a plate, is so secured to the body 12 as to be positioned on the trajectory of the projecting portion 43 of the pin 42 when the mounting bracket 14 is pivoted downwardly (see FIG. 6). The stopper 18 prevents the travel of the mounting bracket 14 and therefore of a chain saw bar 36 mounted thereto when the mounting bracket 14 from being pivoted beyond a predetermined angle.

The stopper 18 is particularly advantageous when the chain saw support 10 is mounted to a work table 50, as illustrated in FIGS. 1 to 6 to prevent the chain 52 and the table 50 from being damaged by a contact between these two elements.

The longitudinal position of the stopper 18 along the body 12 and the thickness of the body 12 may vary to accommodate and to restrain the travel of chain saw plate 36 having different heights.

The stopper 18 may have other forms and configurations without departing from the spirit of the present invention.

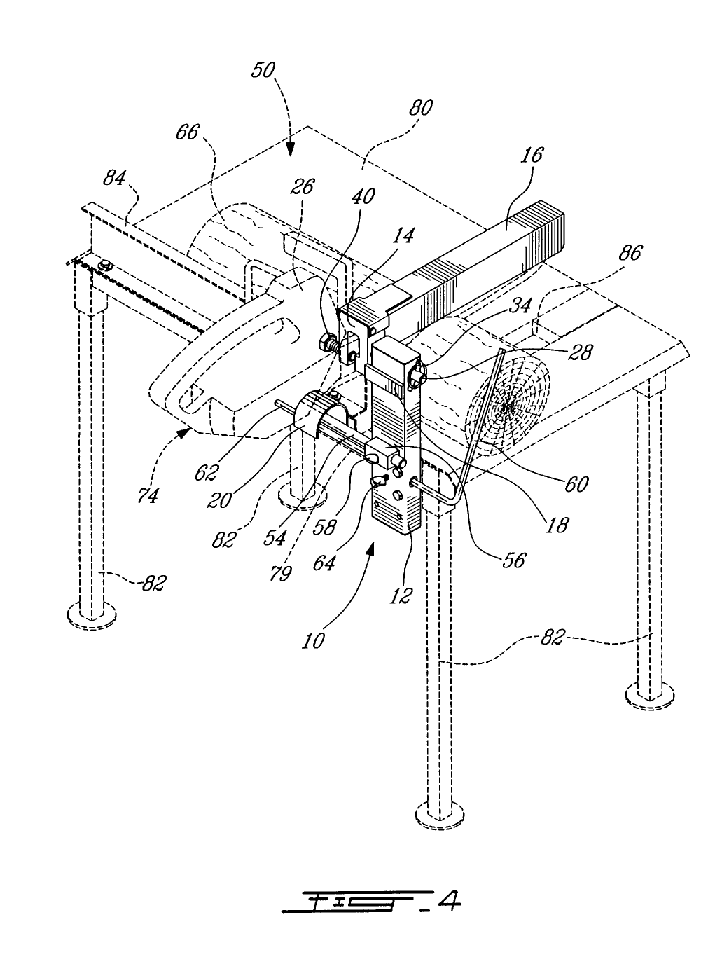

Turning more specifically to FIG. 4, the chain saw rest 20 is slidably mounted to the body 12 via a rod 54. The rod 54 is slidably mounted in a bracket 56 that is secured to the body 12.

The chain saw rest 20 is advantageously in the form of a curved plate so that its pivoting via the rod 54 allows modifying its height (see the comparison between the position of the rest 20 in FIG. 3 and in FIG. 5). A thumbscrew 58 is used to lock the angular and longitudinal position of the chain saw rest 20.

It is believed to be within the reach of someone skilled in the art to conceive other chain saw rest or other means to adjust the height of the rest 20. Alternatively, the chain saw rest 20 may be fixedly mounted to the body so as to be non-adjustable.

A cutting guide 22, in the form of an L-shaped rod is inserted in the body 12 so as to be slidable therein. A first straight portion 60 of the cutting guide 22 is used both as a handle and as a visual guide and the second straight portion 62 includes gradings (not shown) or other reference marks. The marks are so advantageously positioned as to indicate their distance from the first straight portion 60. A thumbscrew 64 is used to lock the position of the cutting guide 22, after setting a length for the cut.

The anchoring assembly 24 includes machine screws 68 that allows to fixedly and removably mount the body 12 to a structure such as the worktable 50. The work table 50 advantageously includes a plate 79 provided with holes for receiving the machine screws 68.

The work table 50 also includes a generally flat surface 80 sitting on four legs 82 and a rip fence 84 mounted to the surface 80 on the side of the chain saw support 10. The flat surface 80 is advantageously provided with a longitudinal aperture 86 that allows passage of the chain saw bar 36 during a downward pivoting movement of the chain saw 74.

As illustrated in FIG. 7, the anchoring assembly 24 may alternatively be in the form of wood screws 70, allowing to secure the portable chain saw support 10 to a tree bole 72.

It is to be noted that the second straight portion 62 of the cutting guide 22 is so alternatively inserted in the body 12 so as to position the first straight portion 60 on the same side than the chain saw relative to the body 12. This allows measuring the length of the log to be cut from its side that is on the same side than the chain saw 74 relative to the body 12.

A cutting guide 22, in the form of an L-shaped rod is inserted in the body 12 so as to be slidable therein. A first straight portion 60 of the cutting guide 22 is used both as a handle and as a visual guide and the second straight portion 62 includes gradings (not shown) or other reference ma.

According to other embodiments of the present invention, the anchoring assembly 24 may include other components or take other forms to allow the chain saw support 10 to be mounted to different structures.

The chain saw support 10 is said to be portable, since it is compact, it can be mounted to different structures and it can be carried in pieces to be easily assembled as follows.

The body 12 is first secured to a structure via its anchoring assembly 24;

The chain saw 74 is secured to the mounting bracket 14, via the chain saw bar 36, using the pivot pin 28 and the pressure screw 32; It may be advantageous to position the chain saw bar 36 generally parallel to the flat side 46 of the mounting bracket 14;

The mounting bracket 14 with the saw 74 is then secured to the body 12 via the pivot pin 28; and

The height of the chain saw rest 20 is adjusted to accommodate the size of the chain saw 74 and the diameter of the log 66 to cut.

In operation, the chain saw support 10 is first secured to a structure, such as a work table 50 or a tree bole 72.

A piece of wood, such as a log 66 is then immobilized on the structure, under the chain saw bar 36, using the cutting guide 22 to select the pre-determined length for the log 66.

The handle 76 of the chain saw 74 is then used to position the chain saw support 10 (and the chain saw 74) in a non cutting position, with the chain 52 near the log 66 (see FIG. 5).

The next step is to pivot the chain saw bar 36, while the motor is running, towards the log 66 in a cutting position (see FIG. 6), until the log 66 is cut and the downward pivoting movement of the chain saw 74 is prevented by the contact of the inwardly projection portion 43 of the pin 42 and the stopper 18.

The chain saw 74 is then repositioned so as to be immobilized on the rest 20 (as illustrated in FIG. 5). It is to be noted that the chain saw support 10 is advantageously configured and sized so that the weight of the chain saw 74 brings the chain saw in the non-cutting position (as illustrated in FIG. 5) when no force is exerted on the chain saw 74.

It is to be noted that the use of the safety pin 34 advantageously allows to easily remove the chain saw 74 from the body 12. This is particularly advantageous when the chain saw 74 needs to be refilled with gasoline, for example.

Although the present invention has been described hereinabove by way of preferred embodiments thereof, it can be modified without departing from the spirit and nature of the subject invention, as defined in the appended claims.

What is claimed is:

1. A portable chain saw support for mounting a chain saw having a power unit to a structure, said support comprising:
a body;
an anchoring assembly mounted to said body; said anchoring assembly being configured to removably mount said body to the structure;
a chain saw mounting bracket pivotally mounted to said body; said chain saw mounting bracket being so configured as to removably receive the chain saw for reciprocal movements between an non-cutting position and a cutting position; and
a chain saw rest so mounted to said body so as to receive the power unit of the chain saw when the chain saw is in said non-cutting position.

2. A portable chain saw support as recited in claim 1, wherein said body has a proximate end and a distal end; said anchoring assembly being mounted to said body near said distal end; said body including a first transversal aperture near said proximate end; said mounting bracket being mounted in said transversal aperture via a pivot pin.

3. A portable chain saw support as recited in claim 2, further comprising a cylinder between said pivot pin and said first transversal aperture.

4. A portable chain saw support as recited in claim 2, wherein said mounting bracket includes a safety pin to prevent transversal movement of said pivot pin in said first aperture.

5. A portable chain saw support as recited in claim 1, wherein said chain saw mounting bracket has an inverted “U” shape defining an inter-space.

6. A portable chain saw support as recited in claim 5, wherein said mounting bracket includes a clamping bolt for securing a chain saw bar in said inter-space.

7. A portable chain saw support as recited in claim 5, wherein said mounting bracket includes first aperture and a removable pin receivable in said first aperture for securing a chain saw bar in said inter-space; said chain saw bar being provided with an aperture for receiving said removable pin.

8. A portable chain saw support as recited in claim 1, wherein said body is a rectangular column.

9. A portable chain saw support as recited in claim 8, wherein said mounting bracket includes a generally flat surface; said mounting bracket is so mounted to said body as to have said generally flat surface facing said rectangular column.

10. A portable chain saw support as recited in claim 9, wherein said rectangular column is hollow.

11. A portable chain saw support as recited in claim 1, further comprising a stopper for limiting pivoting movement of said mounting bracket.

12. A portable chain saw support as recited in claim 1, wherein said is mounting bracket includes a projecting portion; said stopper being in the form of a plate so mounted to said body as to be positioned on the trajectory of said mounting bracket when said mounting bracket is pivoted downwardly.

13. A portable chain saw support as recited in claim 1, wherein said chain saw rest include a bracket mounted to said body, a rod mounted to said bracket and a curved plate fixedly mounted to said rod.

14. A portable chain saw support as recited in claim 13, wherein said rod is slidably mounted to said rest bracket and said further comprising a thumbscrew for selectively locking or releasing said rod in said rest bracket.

15. A portable chain saw support as recited in claim 1, further comprising a chain guard; said chain guard being so pivotally mounted to said mounting bracket as to reciprocate between a cutting position and a non-cutting position.

16. A portable chain saw support as recited in claim 15, wherein said chain saw guard is mounted to said mounting bracket via a mounting plate.

17. A portable chain saw support as recited in claim 15, wherein said chain saw guard has an inverted “U” cross-section.

18. A portable chain saw support as recited in claim 1, further comprising a cutting guide.

19. A portable chain saw support as recited in claim 18, wherein said cutting guiding includes a L-shaped rod having first and second straight portions; said first straight portion being slidably mounted in said body.

20. A portable chain saw support as recited in claim 19, wherein said first straight portion includes reference marks.

21. A portable chain saw support as recited in claim 1, wherein said structure is a work table.

22. A portable chain saw support as recited in claim 21, wherein said worktable includes a generally flat surface provided with a longitudinal aperture; wherein said chain saw support is so mounted to said work table as to be generally aligned with said longitudinal aperture.

23. A portable chain saw support as recited in claim 21, wherein said anchoring assembly includes ma chine screws for securing said body to said worktable; said body being configured to receive said machine screws.

24. A portable chain saw support as recited in claim 1, wherein said structure is a bole; said anchoring assembly including wood screws for securing said body to said bole; said body being configured to receive said wood screws.

25. A portable chain saw support for mounting a chain saw having a power unit to a structure, said support comprising:
a body;
anchoring means mounted to said body; said anchoring means being configured to removably mount said body to the structure;
a chain saw mounting means pivotally mounted to said body; said chain saw mounting means being so configured as to removably receive the chain saw for reciprocal movements between an non-cutting position and a cutting position; and
a chain saw rest mounted o said body so as to receive the power unit of the chain saw when the chain saw is in said non-cutting position.
